(19) United States
(12) Patent Application Publication
(10) Pub. No.: US 2026/0046131 A1
(43) Pub. Date: Feb. 12, 2026

(54) PASS-KEY BASED CREDENTIAL PROCESSING

(71) Applicant: Visa International Service Association, San Francisco, CA (US)

(72) Inventors: Karim Ayad, Toronto (CA); Pieter Pelser, Toronto (CA); Wendy Tsugawa, Toronto (CA)

(73) Assignee: Visa International Service Association, San Francisco, CA (US)

(21) Appl. No.: 19/292,009

(22) Filed: Aug. 6, 2025

Related U.S. Application Data
(60) Provisional application No. 63/679,837, filed on Aug. 6, 2024.

(51) Int. Cl. H04L 9/32

(52) U.S. Cl. CPC H04L 9/3213; H04L 9/3247

(57) ABSTRACT

A computer receives an interaction request message. The computer transmits, to a user device, a relying party identifier associated with a relying party computer. The user device thereafter determines a list of credentials or identifiers thereof based on the relying party identifier. The computer receives the list of credentials or identifiers thereof from the user device. The computer conducts an interaction using a credential, identifier thereof, of the list of credentials or identifiers thereof.

### CROSS-REFERENCES TO RELATED APPLICATIONS

This application claims the benefit of U.S. Provisional Application No. 63/679,837, filed Aug. 6, 2024, which is herein incorporated by reference in its entirety for all purposes.

### BACKGROUND

Current online interactions are lacking in security due to the risk of data breaches. For example, a user can be authenticated during an interaction using authentication data such as biometric data, passwords, or other personally identifiable information (PII) stored in a database. If there is a data breach, then a malicious party can use the exposed data to perform phishing attacks and other security attacks on the user.

In other situations, where the authentication data is not stored in a database, the authentication data can be provided directly by a user device to a resource provider computer to authenticate the user to the resource provider. However, the user is prompted to input the sensitive authentication data into a potentially unknown webpage hosted by the resource provider computer. Such webpages can be a phishing website that poses as the resource provider webpage to maliciously obtain authentication data. Further, if the user device does provide the authentication data to the resource provider computer, the security of the authentication data for the whole interaction system relies on the security level of the communication channel between the user device and the resource provider.

Embodiments of the disclosure address this problem and other problems individually and collectively.

### SUMMARY

One embodiment is related to a method comprising: receiving, by a computer, an interaction request message; transmitting, by the computer to a user device, a relying party identifier associated with a relying party computer, wherein the user device thereafter determines a list of credentials or identifiers thereof based on the relying party identifier; and receiving, by the computer, the list of credentials or identifiers thereof from the user device, wherein the computer conducts an interaction using a credential, identifier thereof, of the list of credentials or identifiers thereof.

Another embodiment is related to a computer comprising: a processor; and a non-transitory computer readable medium comprising code, executable by the processor for performing a method comprising: receiving an interaction request message; transmitting, to a user device, a relying party identifier associated with a relying party computer, wherein the user device thereafter determines a list of credentials or identifiers thereof based on the relying party identifier; and receiving the list of credentials or identifiers thereof from the user device, wherein the computer conducts an interaction using a credential, identifier thereof, of the list of credentials or identifiers thereof.

Another embodiment is related to receiving, by a user device from a computer during an interaction, a relying party identifier associated with a relying party computer; determining, by the user device, a list of credentials or identifiers thereof based on the relying party identifier; providing, by the user device, the list of credentials or identifiers thereof to the computer, wherein the computer obtains a list of tokens corresponding to the list of credentials or identifiers thereof from the relying party computer; receiving, by the user device from the computer, the list of tokens; obtaining, by the user device, a selected token of the list of tokens; and providing, by the user device, the selected token for use in the interaction.

Further details regarding embodiments of the disclosure can be found in the Detailed Description and the Figures.

### BRIEF DESCRIPTION OF THE DRAWINGS

FIG. 1 shows a block diagram of a system according to embodiments.

FIG. 2 shows a block diagram of components of a user device according to embodiments.

FIG. 3 shows a block diagram of components of a computer according to embodiments.

FIG. 4 shows a process flow diagram of a registration method according to embodiments.

FIG. 5 shows a system flow diagram of a registration method according to embodiments.

FIG. 6 shows a process flow diagram of a first portion of an additional device registration method according to embodiments.

FIG. 7 shows a process flow diagram of a second portion of an additional device registration method according to embodiments.

FIG. 8 shows a system flow diagram of an additional device registration method according to embodiments.

FIG. 9 shows a flow diagram of a first registered credential discovery method according to embodiments.

FIG. 10 shows a flow diagram of a second registered credential discovery completion method according to embodiments.

FIG. 11 shows a system flow diagram of a cross-platform method according to embodiments.

### DETAILED DESCRIPTION

Prior to discussing embodiments of the disclosure, some terms can be described in further detail.

A “user” may include an individual or a computational device. In some embodiments, a user may be associated with one or more personal accounts and/or mobile devices. In some embodiments, the user may be a cardholder, account holder, or consumer.

A “user device” may be a device that is operated by a user. Examples of user devices may include a mobile phone, a smart phone, a card, a personal digital assistant (PDA), a laptop computer, a desktop computer, a server computer, a vehicle such as an automobile, a thin-client device, a tablet PC, etc. Additionally, user devices may be any type of wearable technology device, such as watches, earpieces, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

A “user identifier” can include any piece of data that can identify a user. A user identifier can comprise any suitable alphanumeric string of characters. In some embodiments, the user identifier may be derived from user identifying information. In some embodiments, a user identifier can include an account identifier associated with the user.

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment.

“Interaction data” can include data related to and/or recorded during an interaction. In some embodiments, interaction data can be transaction data of the network data. Transaction data can comprise a plurality of data elements with data values.

A “resource provider” may be an entity that can provide a resource such as goods, services, information, and/or access. Examples of resource providers includes merchants, data providers, transit agencies, governmental entities, venue, and dwelling operators, etc.

“Credentials” may comprise any evidence of authority, rights, or entitlement to privileges. For example, access credentials may comprise permissions to access certain tangible or intangible assets, such as a building or a file. Examples of credentials may include passwords, passcodes, or secret messages. In another example, payment credentials may include any suitable information associated with and/or identifying an account (e.g., a payment account and/or payment device associated with the account). Such information may be related to the account or may be derived from information related to the account. Examples of account information may include an “account identifier” such as a PAN (primary account number or “account number”), a token, a subtoken, a gift card number or code, a prepaid card number or code, a user name, an expiration date, a CVV (card verification value), a dCVV (dynamic card verification value), a CVV2 (card verification value 2), a CVC3 card verification value, etc. An example of a PAN is a 16-digit number, such as “4147 0900 0000 1234”. In some embodiments, credentials may be considered sensitive information.

An “authorization request message” may be an electronic message that requests authorization for an interaction. In some embodiments, it is sent to a transaction processing computer and/or an issuer of a payment card to request authorization for a transaction. An authorization request message according to some embodiments may comply with International Organization for Standardization (ISO) 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a username, an expiration date, etc. An authorization request message may also comprise “transaction information,” such as any information associated with a current transaction, such as the transaction value, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g., POS equipment) that indicates approval of the transaction. The code may serve as proof of authorization.

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer, or in some embodiments, a portable device.

A “relying party” may include a server that provides access to a secured application, data, or process. A relying party can verify claims made by entities. A relying party can verify claims made by users and/or user devices regarding the authentication of the users and/or the user devices.

A “relying party identifier” can be a value that identifies a relying party. A relying party identifier can be a value (e.g., an alphanumeric value) that indicates a particular relying party of a plurality of relying parties.

A “public key” can include a cryptographic key that can be made public. A public key can be a cryptographic key that can be obtained and used by any device to encrypt messages intended for a particular recipient, such that the encrypted messages can be deciphered only by using a private key that is known only to the recipient. A public key can be utilized to verify a digital signature created by a private key.

A “private key” can include a cryptographic key that can remain secret. A private key can be a cryptographic key that can remain secret to a particular device or trusted group of devices. A private key can decrypt messages encrypted using a public key that corresponds to the private key. A private key can be utilized to create a digital signature.

A “passkey” can include an authentication credential. A passkey can be utilized to authenticate a user. A passkey can be stored on a user device. A passkey can include a public key and a private key. The public key can be made public and can be shared with a relying party computer or other devices. The private key can remain secret and may only be stored on devices associated with a user. A user can be associated with different passkeys for different credentials and websites. In some embodiments, a passkey can be a Fast Identify Online (FIDO) authentication credential based on FIDO standards, which allows a user to sign in to applications and websites with a similar process that can be used to unlock a device (e.g., biometrics, PIN, pattern, etc.). Passkeys can include FIDO cryptographic credentials that are tied to a user's account on a website or application.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron, and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Embodiments provide for technical solutions to technical problems by leveraging passkeys and web authentication (e.g., WebAuthn) to provide a simple, frictionless, and secure method of presenting an online user with available credentials to utilize during an interaction (e.g., during checkout of a transaction), without the need for providing personally identifiable information manually. Embodiments of the invention can thus include replacing the use of personally identifiable information based login credentials for identifying the available payment credentials in online checkout processing.

Passkey is a method of authentication developed by Fast Identity Online (FIDO) Alliance that is based on cryptographic keys generated on a device and is meant to provide strong authentication without the need for passwords. It includes a phishing-resistant authentication with cryptographic key pairs. FIDO has developed standards that provide for authenticators and relying parties. Together with World Wide Web Consortium (W3C) web authentication (WebAuthn) the standards offer not only the necessary security, but also the flexibility to offer a seamless and frictionless experience.

However, such implementations and combinations of passkeys and WebAuthn are lacking. Embodiments provide systems and methods that allow for registering credentials as being discoverable. Registering the credentials as discoverable and allowing for the credentials to be discovered via a relying party identifier can allow for use cases that alleviate the need for personal information as identifier, since a user handle (e.g., a digital reference that references the user) is returned from the device as part of the discovery. Embodiments define a possible way of leveraging discoverable passkeys to bypass the need for personal information as an ID.

Embodiments provide for a solution that brings card present security and ease of interaction to the online interaction space. A goal is to have users interact online without the need to manually enter their credentials, which exposes their private information and creates friction in the user process. Previous attempts to alleviate such friction points while securing an interaction have only led to more friction and/or additional exposure to sensitive data. A solution should minimize the need for providing and sharing personal information on websites while utilizing a strong authentication method by which the interaction is processed. In particular, solutions so far have relied on email addresses and phone numbers as the personal identification data for the user. However, this presents further challenges and creates a set of new friction experiences of its own such as the user needing to verify their email address or phone number. Additionally, such data does rely on sharing personal information (e.g., the email address or the phone number) and thus exposes such information to the web. Finally, challenges regarding account maintenance, user personal information sharing between ecosystem stakeholders, and user education are presenting challenges in solution implementation.

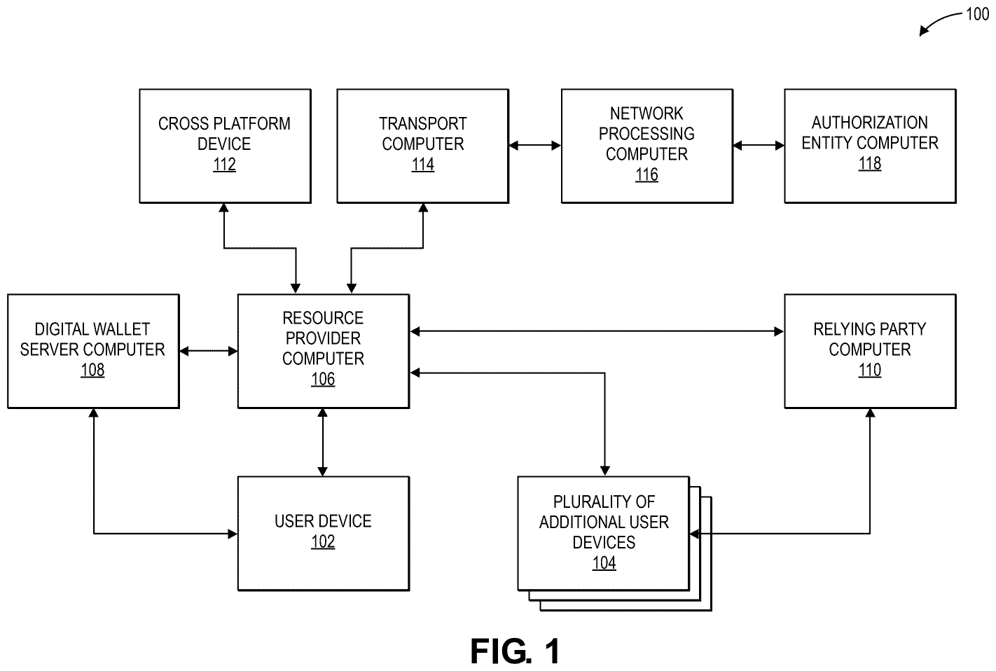

FIG. 1 shows a system 100 according to embodiments of the disclosure. The system 100 comprises a user device 102, a plurality of additional user devices 104, a resource provider computer 106, a digital wallet server computer 108 (an example of a storage application computer), a relying party computer 110, a cross platform device 112, a transport computer 114, a network processing computer 116, and an authorizing entity computer 118.

The user device 102 can be in operative communication with the resource provider computer 106 and the digital wallet server computer 108. The plurality of additional user devices 104 can be in operative communication with the resource provider computer 106 and the relying party computer 110. The resource provider computer 106 can be in operative communication with the digital wallet server computer 108, the relying party computer 110, the cross platform device 112, and the transport computer 114. The network processing computer 116 can be in operative communication with the transport computer 114 and the authorizing entity computer 118.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

Messages between the devices included in the system 100 illustrated in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The user device 102 can include computers, portable computers, laptop computers, tablet computers, mobile devices, cellular phones, wearable devices (e.g., watches, glasses, lenses, clothing, etc.), personal digital assistants (PDAs), Internet of Things (IoT) devices, and/or the like. The user device 102 can initiate interactions (e.g., transactions, data transfers, security webpage access request, etc.) with resource provider computers. For example, the user device 102 can access a resource provider webpage hosted by the resource provider computer 106. The user device 102 can select to checkout using an interaction request message for an interaction between a user of the user device 102 and a resource provider of the resource provider computer 106.

The plurality of additional user devices 104 can include other user devices. In some embodiments, the user device 102 can be a primary user device that has been previously registered in an authentication system. The plurality of additional user devices 104 may not be registered in the authentication system. The user can choose to register one or more of the additional user devices 104.

A device that the user does not want to register with, but is used to initiate an interaction is referred to as the cross platform device 112. The cross platform device 112 can be an untrusted user device (e.g., a computer at a public library) or a device that is operated by a resource provider (e.g., a phone operated by a resource provider at a farmer's market).

The resource provider computer 106 can include any suitable computational apparatus operated by a resource provider (e.g., a merchant, an access provider, etc.). In some embodiments, the resource provider computer 106 may include one or more server computers that may host one or more webpages associated with the resource provider. In some embodiments, the resource provider computer 106 may be configured to send data to the network processing computer 116 via the transport computer 114 as part of a payment verification and/or authentication process for a transaction between the user (e.g., consumer) and the resource provider. The resource provider computer 106 may also be configured to generate authorization request messages for transactions between a resource provider and a user, and route the authorization request messages to the authorizing entity computer 118 for transaction processing.

The digital wallet server computer 108 can be an example of a storage application server computer which stores data such as credentials. The digital wallet server computer 108 can be a checkout manger computer. The digital wallet server computer 108 can maintain a digital wallet application. The digital wallet application can be installed on the user device 102, the plurality of additional user devices 104 and/or the cross platform device 112. The digital wallet server computer 108 can aid in a checkout process for an interaction between the user and the resource provider. The digital wallet server computer 108 can process the interactions and can communicate with the user device 102 regarding credentials. In some embodiments, the digital wallet server computer 108 can be included in the resource provider computer 106.

The relying party computer 110 can include a computer or a server computer that can authenticate the user and/or the user device 102. The relying party computer 110 can be configured to authenticate the user device 102 by verifying a digital signature produced by a private key on the user device. The relying party computer 110 can verify the digital signature using a public key stored on the relying party computer. In some embodiments, a relying party can be a webpage or other entity that uses a FIDO protocol to directly authenticate users (e.g., performs peer entity authentication). A relying party identifier can enable issuers of passkeys to uniquely identify a resource provider, resource provider computer, and/or resource provider application that is managing the authentication process.

The transport computer 114 can include a server computer. The transport computer 114 may be associated with an acquirer, which may be an entity (e.g., a commercial bank) that has a relationship with a particular merchant or other entity. Some entities can perform both issuer and acquirer functions. Some embodiments may encompass such single entity issuer-acquirers.

The network processing computer 116 can include a server computer. The network processing computer 116 may be disposed between the transport computer 114 and the authorizing entity computer 118. The network processing computer 116 may include data processing subsystems, networks, and operations used to support and deliver authorization services, exception file services, and clearing and settlement services. For example, the network processing computer 116 may comprise a server coupled to a network interface (e.g., by an external communication interface), and databases of information. The network processing computer 116 may be representative of a transaction processing network. An exemplary transaction processing network may include VisaNet™. Transaction processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The network processing computer 116 may use any suitable wired or wireless network, including the Internet.

The authorizing entity computer 118 can include a server computer operated by an authorizing entity. The authorizing entity computer 118 may be associated with an authorizing entity, which may be an entity that authorizes a request. An example of an authorizing entity may be an issuer, which may be an entity (e.g., a bank, a secure webpage, etc.) that maintains an account for a user. An issuer may also issue and manage an account associated with the user device 102.

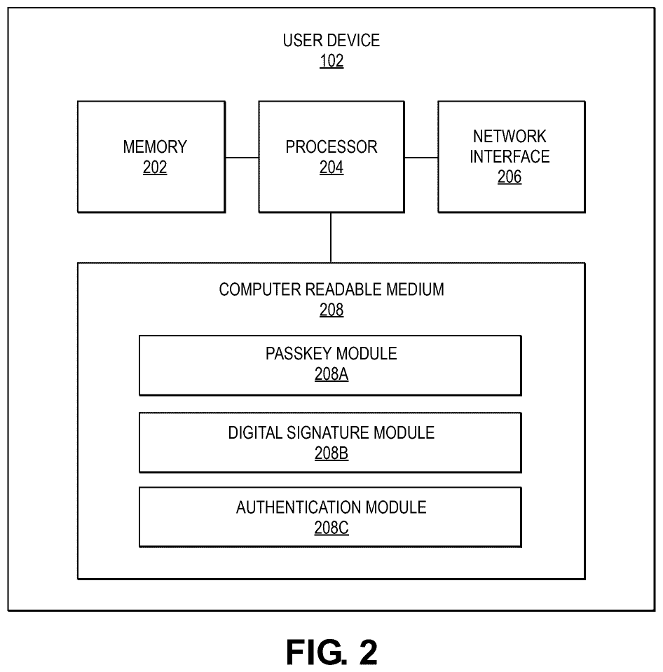

FIG. 2 shows a block diagram of a user device 102 according to embodiments. The exemplary user device 102 may comprise a processor 204. The processor 204 may be coupled to a memory 202, a network interface 206, and a computer readable medium 208. The computer readable medium 208 can comprise one or more modules. The computer readable medium 208 can comprise a passkey module 208A, a digital signature module 208B, and an authentication module 208C.

The memory 202 can be used to store data and code. For example, the memory 202 can store interaction data, cryptographic keys, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: receiving, by a user device from a computer during an interaction, a relying party identifier associated with a relying party computer; determining, by the user device, a list of credentials or identifiers thereof based on the relying party identifier; providing, by the user device, the list of credentials or identifiers thereof to the computer, wherein the computer obtains a list of tokens corresponding to the list of credentials or identifiers thereof from the relying party computer; receiving, by the user device from the computer, the list of tokens; obtaining, by the user device, a selected token of the list of tokens; and providing, by the user device, the selected token for use in the interaction.

The passkey module 208A may comprise code or software, executable by the processor 204, for creating and maintaining passkeys. The passkey module 208A, in conjunction with the processor 204, can generate passkeys. The passkey module 208A, in conjunction with the processor 204, can generate a public key and private key pair for the passkey. The passkey module 208A, in conjunction with the processor 204, can generate an asymmetric key pair for the passkey, where the public key is a sharable public portion of the passkey, and where the private key is a secret portion of the passkey. The passkey module 208A, in conjunction with the processor 204, can generate cryptographic keys in any suitable manner known to one of skill in the art.

The digital signature module 208B may comprise code or software, executable by the processor 204, for creating digital signatures. The digital signature module 208B, in conjunction with the processor 204, can generate digital signatures using private keys. For example, the digital signature module 208B, in conjunction with the processor 204, can generate a digital signature using a private key from a passkey generated by the passkey module 208A.

The authentication module 208C may comprise code or software, executable by the processor 204, for performing authentication operations. The authentication module 208C, in conjunction with the processor 204, can authenticate a user of the user device 102. The authentication module 208C, in conjunction with the processor 204, can obtain user input data from the user (e.g., a biometric, a password, a pin, a pattern, etc.) and can compare the input data to stored data. The authentication module 208C, in conjunction with the processor 204, can determine whether or not the input data matches the stored data. If the input data matches the stored data, then the authentication module 208C, in conjunction with the processor 204, can determine that the user is authentic and can prompt the digital signature module 208B to sign authentication data using the private key of the passkey.

The network interface 206 may include an interface that can allow the user device 102 to communicate with external computers. The network interface 206 may enable the user device 102 to communicate data to and from another device (e.g., the resource provider computer 106, the digital wallet server computer 108, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

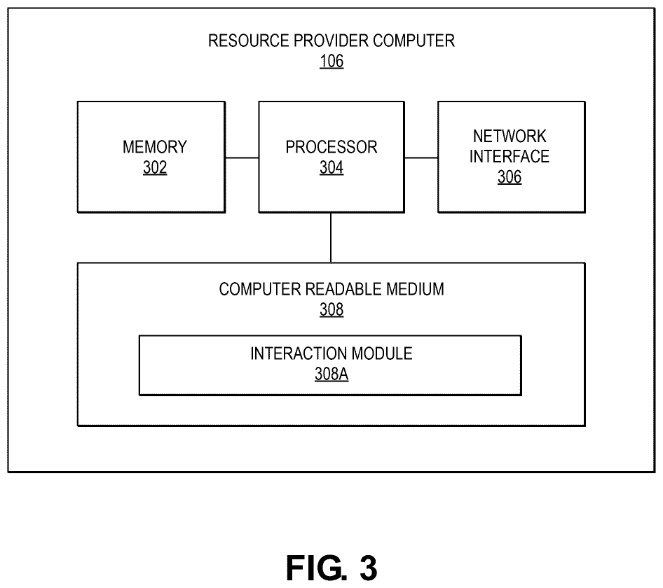

FIG. 3 shows a block diagram of a resource provider computer 106 according to embodiments. The exemplary resource provider computer 106 may comprise a processor 304. The processor 304 may be coupled to a memory 302, a network interface 306, and a computer readable medium 308. The computer readable medium 308 can comprise one or more modules. The computer readable medium 308 can comprise an interaction module 308A.

The memory 302 can be used to store data and code and may be similar to the memory 202 as described herein. The memory 302 can store, for example, interaction data, cryptographic keys, relying party identifiers, etc.

The computer readable medium 308 may comprise code, executable by the processor 304, for performing a method comprising: receiving, by a computer, an interaction request message; transmitting, by the computer to a user device, a relying party identifier associated with a relying party computer, wherein the user device thereafter determines a list of credentials or identifiers thereof based on the relying party identifier; and receiving, by the computer, the list of credentials or identifiers thereof from the user device, wherein the computer conducts an interaction using a credential, identifier thereof, of the list of credentials or identifiers thereof.

The interaction module 308A may comprise code or software, executable by the processor 304, for performing interactions. The interaction module 308A, in conjunction with the processor 304, can process interactions between a resource provider of the resource provider computer 106 and a user of the user device 102. The interaction module 308A, in conjunction with the processor 304, can generate interaction data for the interaction. The interaction data can include a resource provider computer identifier, a user device identifier, a credential (e.g., a credential selected by the user) or a token for the credential, an amount, a date, a time, an interaction type, user authentication data, and/or other data related to processing or authorizing the interaction.

The network interface 306 may be similar to the network interface 206 and will not be repeated here.

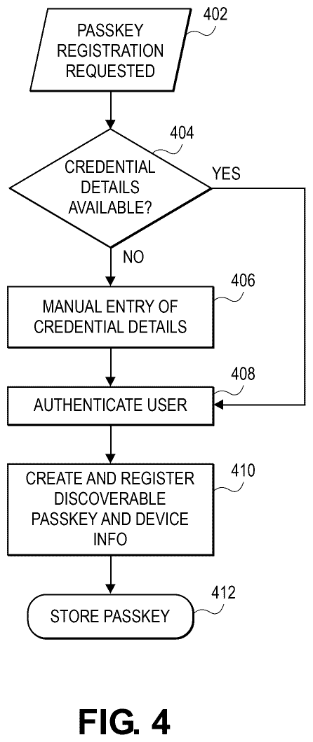

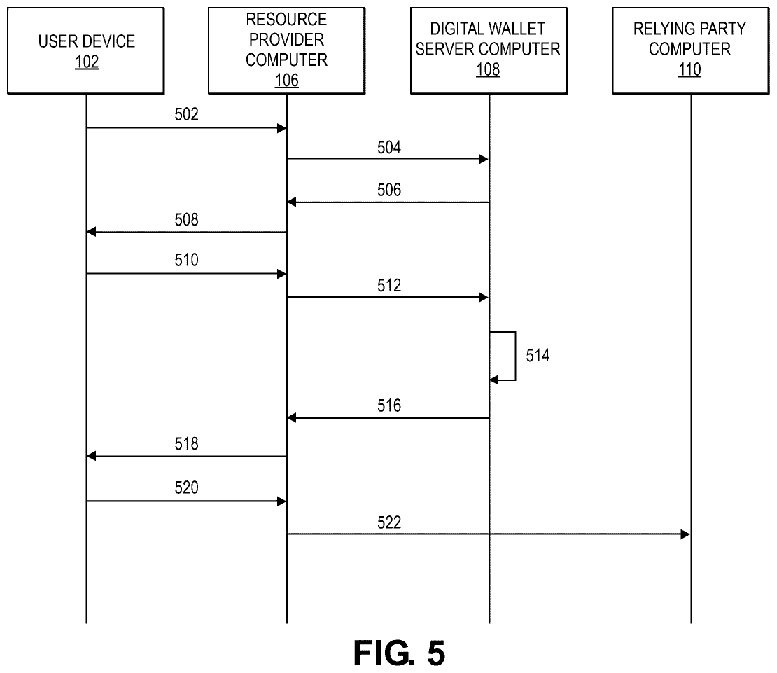

This section outlines the process and system flows that can be utilized to register a credential passkey into a user device for the first time. FIGS. 4-5 illustrate registration methods. The methods in FIGS. 4-5 can be implemented in the context of authenticating with a banking application, authenticating with a trusted third-party website, authenticating with a third-party application, authenticating with a government entity, etc. The first-time registration can be done securely and can ensure a step-up authentication is made. The registration can be initiated in any suitable manner. For example, a manual entry option is given to the user. Additionally, other methods might be used if the user has access to the card including using a cardholder verification method (CVM).

FIG. 4 shows a process flow diagram of a registration method according to embodiments. The method illustrated in FIG. 4 can be performed by the user device 102.

At step 402, passkey registration can be requested. The user device 102 can initiate passkey registration. For example, the user can request the user device 102 to perform passkey registration for a particular account associated with the user.

In some embodiments, the passkey registration process can be prior to initiating an interaction with a resource provider computer. In other embodiments, the passkey registration process can be initiated when initiating an interaction or during an interaction with the resource provider computer. For example, this step may be a first step of a user interaction or can be performed as part of a checkout experience or during initiation of registration into the interaction system. In some embodiments, passkey registration can be requested as part of the card activation if the authentication service is an issuer-offered authentication service.

The user device 102 can generate a passkey registration request message. The passkey registration request message can include a user device identifier. The user device 102 can provide the passkey registration request message to the digital wallet server computer 108 or to the relying party computer 110 for registration with a passkey authentication service. In some embodiments, if registration occurs during an interaction, then the user device 102 can provide the passkey registration request message to the resource provider computer 106 along with or in an interaction request message.

At step 404, the user device 102 can verify that credential details are available for creating a passkey for a credential (e.g., a payment credential). The credential details can include information related to a card (e.g., a portable device such as a transit pass, a credit card, a debit card, a rewards card, etc.) or account associated with the user. The credential details can include a primary account number, an expiry date, a name, a security code, a location, and/or other identifying details. For example, the user device 102 can verify that credential details are stored in the user device 102. For example, the user device 102 can store a digital wallet application that may store credential details on behalf of the user. If there are no credential details available on the user device 102, the user device 102 can proceed to step 406. If there are credential details available on the user device 102, the user device 102 can proceed to step 408.

At step 406, if there are no credential details available, the user device 102 can prompt the user to enter credential details into the user device 102. The user device 102 can receive the credential details from the user (e.g., via a keyboard, a touch screen, a microphone, or other input device).

At step 408, after obtaining the credential details, the user device 102 can authenticate the user of the user device 102 that is associated with the credential details. The user device 102 can authenticate the user in any suitably secure manner. For example, the user device 102 can authenticate the user by requesting and verifying the authenticity of a user biometric (e.g., a fingerprint).

For example, the user device 102 can prompt the user to provide a photo of the user's face for biometric comparison to a stored photo of the user's face and/or a stored facial biometric. The user device 102 can determine a biometric comparison. A biometric comparison can be an estimation, calculation, or measurement of similarity or dissimilarity between the biometric sample (e.g., the user's input) and a biometric reference (e.g., a stored reference).

If the user is not authenticated, then the user device 102 can terminate the process, prompt the user to reinput a biometric, and/or return to a previous step in the process. If the user is authenticated then the process can proceed to step 410.

At step 410, after the user is authenticated, the process of creating a passkey can be performed. The user device 102 can create a passkey that is associated with the user and/or the credential details. The passkey can be created as discoverable as per WebAuthn specifications as this can allow for a seamless experience upon subsequent transactions.

The user device 102 can create a passkey by generating a cryptographic public key and a corresponding cryptographic private key. For example, the user device 102 can generate a public private key pair using an RSA (Rivest-Shamir-Adleman) cryptographic generation process.

In some embodiments, the passkey can be a per interaction credential passkey. In other embodiments, the user can be associated with an overarching user account with multiple credentials and passkeys associated with the user account, where the user can update the user account with additional credentials at a later times.

At step 412, after generating the passkey, the user device 102 can store the passkey. For example, the user device 102 can store the cryptographic public key and the cryptographic private key. In some embodiments, the user device 102 can store the passkey in a digital wallet application installed on the user device 102 that is provided by the digital wallet server computer 108.

FIG. 5 shows a system flow diagram of a registration method according to embodiments. The steps performed in reference to FIG. 5 can be performed in addition to or in place of the steps performed in reference to FIG. 4. The method illustrated in FIG. 5 describes details passkey creation.

At step 502, the user device 102 can provide credential details entered by a user into the user device 102 to a resource provider webpage hosted by the resource provider computer 106. For example, the user device 102 can initiate an interaction and can proceed to checkout with the resource provider computer 106. The user device 102 can provide credential details such as a primary account number to the resource provider computer 106 during checkout.

At step 504, the resource provider webpage can verify with the digital wallet server computer 108 whether or not the card has been previously registered. The resource provider webpage can perform this verification because there could be an option provided for the user to register a secondary/additional device using the primary registered device for a more secure and streamlined registration, as described in further detail herein.

For example, the resource provider computer 106, which is hosting the resource provider webpage, can generate a registration verification request message comprising the credential details. The resource provider computer 106 can provide the registration verification request message to the digital wallet server computer 108.

At step 506, after receiving the registration verification request message, the digital wallet server computer 108 can search a database for stored data that matches the received credential data. For example, the digital wallet server computer 108 can receive a primary account number for the credential. The digital wallet server computer 108 can search the database for a user authentication account that is associated with the primary account number. The digital wallet server computer 108 can determine whether or not there is a user authentication account based on the primary account number or other credential details.

The digital wallet server computer 108 can generate a registration verification response message that indicates whether or not the credential associated with the credential details is registered. For example, the registration verification response message can indicate that the credential is not registered. The digital wallet server computer 108 can provide the registration verification response message to the resource provider computer 106.

At step 508, after receiving the registration verification response message, the resource provider computer 106 can evaluate the registration verification response message to determine whether or not the credential is registered. If the credential is registered, then the resource provider computer 106 can proceed to process the interaction, as described herein.

If the credential is not registered, then the resource provider computer 106 can generate a registration option message. The resource provider computer 106 can provide the registration option message to the user device 102. The registration option can provide the user of the user device 102 to select whether or not to register into the system. For example, if the credential is eligible for registration and has not been registered, the user of the user device 102 can be requested to authenticate themselves and confirm the acceptance of registration.

At step 510, after receiving the registration option message, the user device 102 can prompt the user with the option to register the credential related to the credential details. The user can be presented, by the user device 102, of whether or not to register the credential. If the user selects to register the credential, then the user device 102 can generate an agreement message that indicates agreement to the registration. The user device 102 can provide the agreement message to the resource provider computer 106.

In some embodiments, the user device 102 can also perform an authentication process to authenticate the user of the user device 102. The agreement message can also include authentication data that indicates that the user of the user device 102 is authenticated.

At step 512, after receiving the agreement message, the resource provider computer 106 can generate a token creation request message that requests the creation of a token (e.g., a payment credential token, an access credential token, etc.). The resource provider computer 106 can provide the token creation request message to the digital wallet server computer 108. The token creation request message can include the credential details. The token creation request message can also include a user device identifier. In some embodiments, the token creation request message can comprise the authentication data that indicates that the user of the user device 102 is authenticated.

At step 514, after receiving the token creation request message, the digital wallet server computer 108 can generate a token for the credential details. The digital wallet server computer 108 can store the token into a secure database. The digital wallet server computer 108 can generate a client identifier. The digital wallet server computer 108 can store the client identifier in association with the token. The client identifier can identify a client device (e.g., the user device 102) that is related to the token.

The digital wallet server computer 108 can also obtain a relying party identifier that identifies a particular relying party computer 110 that can be designated as a computer that validates the passkey of the user device 102.

At step 516, after generating the token, the digital wallet server computer 108 can generate a token creation response message. The digital wallet server computer 108 can provide the token creation response message to the resource provider computer 106. In some embodiments, the token creation response message can comprise the token for use in a current interaction and/or for provisioning to the user device 102. The digital wallet server computer 108 can also provide the relying party identifier to the resource provider computer 106.

At step 518, the resource provider computer 106 can prompt the user device 102 to generate a passkey. The resource provider computer 106 can provide the relying party identifier to the user device 102. In some embodiments, the resource provider computer 106 can provide the token to the user device 102.

For example, the resource provider computer 106 can generate a passkey creation message comprising the relying party identifier. The passkey creation message can indicate that the user has been successfully registered in the passkey system and prompt the user device 102 to generate a passkey for the token and credential. The resource provider computer 106 can provide the passkey creation message to the user device 102.

The user device 102 can generate the passkey. The user device 102 can generate a public key and a private key. The user device 102 can store the public key and the private key in association with the credential details, the credentials, and/or the token.

The user device 102 can generate the passkey to be a discoverable passkey that is associated with a relying party identifier. For example, the user device 102 can create the passkey such that when a relying party identifier is received, the received relying party identifier is compared to relying party identifiers associated with one or more passkeys stored in the user device 102. The user device 102 can filter the potential passkeys based on the relying party identifier by allowing the device that provided the relying party identifier to discover passkeys stored in association with a matching relying party identifier.

At step 520, after generating the passkey, the user device 102 can provide the public key to the resource provider computer 106.

At step 522, after receiving the public key from the user device 102, the resource provider computer 106 can provide the public key associated with the passkey of the user device 102 to the relying party computer 110.

The relying party computer 110 can store the public key into a secure database. At a point later in time, for example, during an interaction, the relying party computer 110 can provide the public key to the digital wallet server computer 108, or another device, upon request.

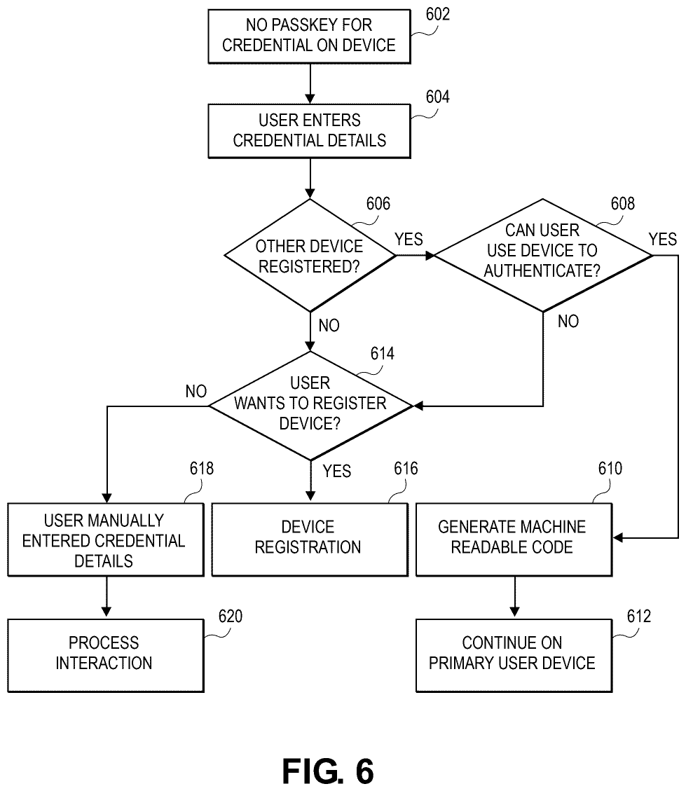

This section discusses adding additional credential passkeys on an additional/secondary device after a primary user device has already been registered. FIGS. 6-8 describe such methods. A primary device can be device with a previously registered passkey for a payment credential. There could be an additional identification of a primary device as a device where historically it has been used by the user to an extent that it is deemed more secure. Additionally, there can be other mechanisms to give priority to devices used for authentication purposes (e.g., a bank registered device) to allow for an additional device to be registered. This section describes leveraging the previously registered passkey as an authentication mechanism for registering subsequent devices.

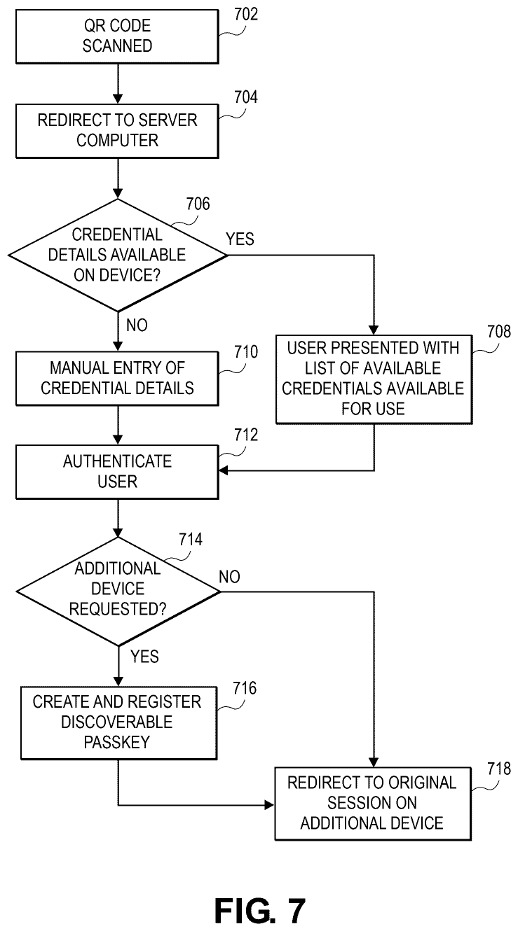

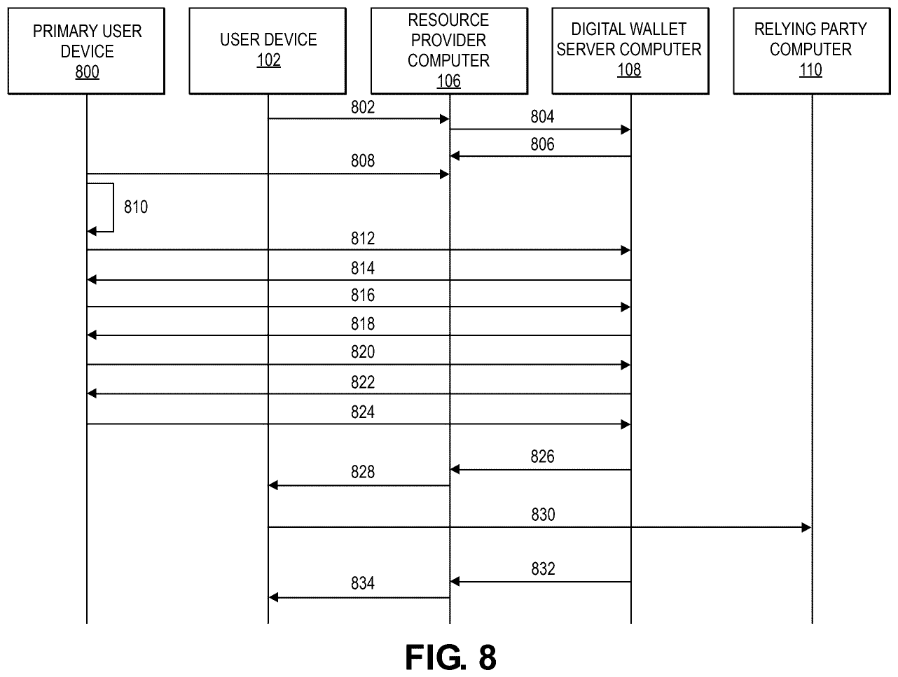

FIG. 6 shows a process flow diagram of a first portion of an additional device registration method according to embodiments. FIG. 6 illustrates a method for identifying an additional device and registering passkeys on it. The method illustrated in FIG. 6 is continued in reference to FIG. 7 below. FIG. 8 illustrates a similar method as the method depicted in FIGS. 6-7 and will be referenced accordingly.

The method illustrated in FIG. 6 will be described in the context of the user of the user device 102 performing an interaction with the resource provider computer 106 using the user device 102. The user device 102 may not yet be registered. Prior to processing the interaction, the user device 102 can determine whether or not a list of credentials or identifiers thereof (e.g., credentials associated and identified by a public key of a passkey) are stored on the user device 102. Passkeys, as described herein, can be created as discoverable using a relying party identifier. For example, the list of credentials or identifiers thereof includes a list of credentials associated with and identified by public keys of passkeys.

At step 602, during the interaction, the user device 102 can determine that there is not a passkey for a credential on the user device 102. In particular, the user device 102 can determine that there is not a list of credentials or identifiers thereof stored on the user device 102. For example, when communicating with the resource provider computer 106 for an interaction (e.g., when loading a resource provider webpage), the user device 102 can determine whether or not a list of credentials or identifiers thereof stored on the user device 102 for use in interactions.

At step 604, after determining that there are no passkeys on the user device 102, the user device 102 can prompt the user of the user device 102 to input credential details into the user device 102. In some embodiments, the user device 102 can present an option to the user to self-identify whether or not the user has registered on a different user device rather than prompting the user for the credential details.

For example, the user device 102 can prompt the user to input credential details that include the last four digits of a primary account number.

At step 606, after the credential details are obtained, the user device 102 can communicate with the digital wallet server computer 108 or a digital wallet application installed on the user device 102 to determine whether or not the credential details are associated with a different user device that has been previously registered. The user device 102, the digital wallet server computer 108, and/or the digital wallet application can determine whether or not the credential details are associated with another registered device. The other registered device can be referred to as the primary user device. If another device is registered, then the process can proceed to step 608. If another device is not registered, then the process can proceed to step 614.

At step 608, if the primary user device has been previously registered, an additional check can be performed to determine whether or not the user can utilize the primary user device for authentication for the current interaction. The additional check can be performed by the user device 102, the digital wallet server computer 108, and/or the digital wallet application. For example, the user device 102 can prompt the user with a question that asks the user whether or not the primary user device is usable for interaction (e.g., within reach of the user, etc.). The user device 102 can obtain an answer to the question of whether or not the user has the primary user device available and whether or not the user can use the primary user device for completing the registration of the user device 102 (e.g., the additional device). As another example, the digital wallet server computer 108 can determine whether or not the user can use the primary user device to authenticate themselves.

If the user can use the primary user device for authentication, then the process can proceed to step 610. If the user cannot use the primary user device for authentication, then the process can proceed to step 614.

At step 610, if the user can use the primary user device (e.g., which is registered), then the user device 102, the digital wallet server computer 108, and/or the digital wallet application can redirect the user to the primary user device to complete the registration.

For example, the digital wallet server computer 108 can generate a machine readable code that can be displayed on the user device 102. The machine readable code, when scanned (e.g., read) by the primary user device can direct the primary user device to form a communication channel with the digital wallet server computer 108. The machine readable code can be a QR code, a barcode, etc. The QR code can embed a webpage URL and a session identifier that can identify a current session between the user device 102 and the resource provider computer 106.

For example, the primary user device can be redirected using a QR code displayed on the user device 102. The digital wallet server computer 108 can generate a dynamic QR code. The dynamic QR code can be presented on the user device 102 for the user to scan with the identified primary user device. The dynamic QR code can point the primary user device to the digital wallet server computer 108.

In some embodiments, other methods of redirection could be used (e.g., a Web Authn Bluetooth method).

At step 612, after the dynamic QR code is scanned with the primary user device, the process can continue utilizing the primary user device. The process can continue at step 702 as described in reference to FIG. 7, below.

At step 614, if there were either no previous registrations or the user cannot use the registered primary user device, then the user device 102 can prompt the user with a question for whether or not the user wants to register the user device 102. The user can input an indication of whether or not the user is requesting to register the user device 102. If the user device 102 is to be registered as, then the process can proceed to step 616. If the user device is not to be registered, then the process can proceed to step 618.

At step 616, if the user wants to register the current user device 102, then the current user device 102 can be registered using a registration process, as described herein. In some embodiments, if there is no other user device that is registered for the user, then the user device 102 can be treated as the primary user device for registration. For example, the methods of FIG. 4 or 5 can be performed to register the user device 102.

At step 618, if the user decides not to register the user device 102 with the digital wallet server computer 108, then the user device 102 can perform an interaction with the resource provider computer 106 with the manually entered credential details obtained at step 604.

FIG. 7 shows a process flow diagram of a second portion of an additional device registration method according to embodiments. The method illustrated in FIG. 7 can be a continuation of the method illustrated in FIG. 6, and follows the redirection of the user to the primary user device to complete the registration of additional user device 102. For example, the method illustrated in FIG. 7 can be performed as step 612 of FIG. 6.

At step 702, the primary user device can scan the machine readable code (e.g., a dynamic QR code) displayed by the user device 102. For example, the user can utilize the primary user device to use a camera in the primary user device to scan the QR code.

At step 704, after scanning the machine readable code, the primary user device can be redirected to connect to the digital wallet server computer 108. The primary user device can provide a session identifier obtained from the QR code to digital wallet server computer 108. For example, the primary user device can be redirected to a webpage hosted by the digital wallet server computer 108 that will continue with the registration of the user device 102.

In some embodiments, if the user mistakenly scanned the QR code on a non-registered device, and the redirection detects that the device is not registered, then the user can be prompted to register both devices. However, such a process can also be handled as an error message asking the user to continue the flow on the previous user device 102 without involving the non-registered device used to scan the QR code.

At step 706, after establishing a communication channel with the primary user device, the digital wallet server computer 108 can determine whether or not a list of credentials or identifiers thereof (e.g., credentials associated and identified by a public key of a passkey) are available on the primary user device. If no list of credentials or identifiers thereof are available on the primary user device, then the process proceeds to step 712. If a list of credentials or identifiers thereof is available on the primary user device, then the process proceeds to step 708.

For example, the digital wallet server computer 108 can generate a credential request message comprising a relying party identifier. The digital wallet server computer 108 can provide the credential request message to the primary user device. The relying party identifier can be associated with the relying party computer 110. The digital wallet server computer 108 can discover the available passkeys on the primary user device. The primary user device can determine a list of credentials or identifiers thereof based on the relying party identifier. The primary user device can generate a credential response message comprising the list of credentials or identifiers thereof. The primary user device can provide the credential response message to the requester.

At step 708, after obtaining the list of credentials or identifiers thereof, the digital wallet server computer 108 can provide a credential selection request message to the primary user device. The credential selection request message can include a request for the user of the primary user device to select one or more credentials or identifiers thereof of the list of credentials or identifiers thereof. The credential selection request message can include the list of credentials or identifiers thereof. In some embodiments, a list of selectable credentials or identifiers thereof can be a subset of the list of credentials or identifiers thereof.

The primary user device can receive input from the user that indicates a selected credential or identifier thereof. The primary user device can generate a credential selection response message comprising the selected credential or identifier thereof. The primary user device can provide the credential selection response message to the digital wallet server computer 108. After receiving the credential selection response message, the process can proceed to step 712.

At step 710, if no credential details are available on the primary user device, then the user can be prompted to enter the credential details into the primary user device. The user can input credential details into the primary user device.

At step 712, after obtaining the credential details or one or more selected credentials or identifiers thereof, the user can be authenticated using an authentication process (e.g., using a biometric authentication process). If the user is authenticated, then the process can proceed to step 716. If the user is not authenticated, then the process can be terminated, retried, or returned to a previous step. An example user authentication process can include steps 822-824 as described in reference to FIG. 8, below.

At step 714, after the user is authenticated, the digital wallet server computer 108 can determine whether or not an additional user device (e.g., the user device 102) is requested to be registered (e.g., where the additional device is the device that presented the QR code to the primary user device). The user can have the option of registering the user device 102. If the additional user device is requested to be registered, then the process can proceed to step 716. If the additional user device is not requested to be registered, then the process can proceed to step 718.

At step 716, the digital wallet server computer 108 can initiate passkey creation. In some embodiments, the digital wallet server computer 108 can prompt the user device 102 to create a passkey. In other embodiments, the digital wallet server computer 108 can create and provision a passkey to the user device 102. For example, passkey creation of step 716 can include steps 826-830 as described in reference to FIG. 8, below.

At step 718, the processing of the interaction can be redirected to the original session on the user device 102 using the session identifier. The user device 102 can proceed with the interaction with the resource provider computer using the passkey. The original session can be resumed on the user device 102 as described during steps 832-834 as described in reference to FIG. 8, below.

The resource provider computer 106 can also generate an authorization request message that requests authorization for the interaction. The authorization request message can comprise the credentials. The resource provider computer can provide the authorization request message to a network processing computer via a transport computer. The network processing computer can provide the authorization request message to an authorizing entity computer for authorization of the interaction.

The authorizing entity computer can determine whether or not to authorize the interaction. The authorizing entity computer can generate an authorization response message comprising an indication of whether or not the interaction is authorized. The authorizing entity computer can provide the authorization response message to the resource provider computer via the network processing computer and the transport computer.

After the interaction is authorized, a clearing and/or settlement process can occur between the network processing computer, the authorizing entity computer, and a transport computer associated with the resource provider.

FIG. 8 shows a system flow diagram of an additional device registration method according to embodiments. FIG. 8 can describe a process similar to the method illustrated in FIGS. 6-7.

At step 802, the user device 102 can initiate registration during checkout for an interaction between the user of the user device 102 and a resource provider of the resource provider computer 106. The user device 102 can provide an enrollment request message to the resource provider computer 106. In some embodiments, the user device 102 can provide an interaction request message for an interaction, where the interaction request message includes an enrollment request.

At step 804, the resource provider computer 106 can request a dynamic QR code from the digital wallet server computer 108. For example, the resource provider computer 106 can generate a machine readable code request message that requests enrollment of the user device 102.

In some embodiments, the digital wallet server computer 108 can be included in the resource provider computer 106. At step 806, the digital wallet server computer 108 can create the dynamic QR code for the user to scan using a primary user device 800 and continue the processing of the registration using the primary user device 800. The digital wallet server computer 108 can provide the dynamic QR code to the resource provider computer 106. The resource provider computer 106 can display the dynamic QR code on, for example, a webpage hosted by the resource provider computer 106 that is being accessed by the user device 102.

At step 808, the primary user device 800 can scan the QR code displayed on the user device 102 that is displaying the QR code from the resource provider computer webpage.

At step 808, the primary user device 800 can scan the dynamic QR code displayed by the user device 102. For example, the user can utilize the primary user device 800 to use a camera in the primary user device 800 to scan the QR code.

At steps 810 and 812, after scanning the QR code, the primary user device 800 can be redirected to connect to the digital wallet server computer 108. The primary user device 800 can provide a session identifier obtained from the QR code to the digital wallet server computer 108. For example, the primary user device 800 can be redirected to a webpage hosted by the digital wallet server computer 108 that will continue with the registration of the user device 102.

In some embodiments, if the user mistakenly scanned the QR code on a non-registered device, and the redirection detects that the device is not registered, then the user can be prompted to register both devices. However, such a process can also be handled as an error message asking the user to continue the flow on the previous user device 102 without involving the non-registered device used to scan the QR code.

For example, steps 814-816 of FIG. 8 can be performed during step 706 as illustrated in FIG. 7. At step 814, the digital wallet server computer 108 can generate a credential request message comprising a relying party identifier. The digital wallet server computer 108 can provide the credential request message to the primary user device 800. The relying party identifier can be associated with the relying party computer 110. The digital wallet server computer 108 can discover the available passkeys on the primary user device 800.

The primary user device 800 can then determine a list of credentials or identifiers thereof based on the relying party identifier. The primary user device 800 can generate a credential response message comprising the list of credentials or identifiers thereof.

At step 816, the primary user device 800 can provide the credential response message to the requester. The list of credentials or identifiers thereof can include credentials or identifiers thereof that are available to register on the user device 102.

At step 818, after obtaining the list of credentials or identifiers thereof, the digital wallet server computer 108 can provide a credential selection request message to the primary user device 800. The credential selection request message can include a request for the user of the primary user device 800 to select one or more credentials or identifiers thereof of the list of credentials or identifiers thereof. The credential selection request message can include the list of credentials or identifiers thereof.

At step 820, the primary user device 800 can receive input from the user that indicates a selected credential or identifier thereof. The primary user device 800 can generate a credential selection response message comprising the selected credential or identifier thereof. In some embodiments, the primary user device 800 can receive input of one or more selected credentials or identifiers thereof. The primary user device 800 can provide the credential selection response message to the digital wallet server computer 108.

At step 822, the digital wallet server computer 108 can initiate an authentication challenge for the primary user device 800. The authentication challenge can be a passkey user authentication challenge. The authentication challenge can include a challenge for the user to biometrically authenticate themselves using the primary user device 800.

The primary user device 800 can receive the authentication challenge. The primary user device 800 can prompt the user of the primary user device 800 to authenticate themselves in such a manner to satisfy the authentication challenge. For example, the primary user device 800 can prompt the user to input a user biometric (e.g., a fingerprint). The primary user device 800 can compare a captured biometric to a stored biometric to determine whether or not the user is authentic. The primary user device 800 can generate authentication data that indicates whether or not the user is authentic. The authentication data can also include information on what authentication process was used, a confidence level, and/or other data related to the authentication process and/or the user.

At step 824, upon successful authentication of the user, the primary user device 800 can notify the digital wallet server computer 108 of the successful authentication and/or proof of authentication. For example, the primary user device 800 can generate a challenge response message that includes the authentication data. The primary user device 800 can provide the challenge response message to the digital wallet server computer 108.

At step 826, the digital wallet server computer 108 can initiate passkey creation for the additional user device. The digital wallet server computer 108 can create a passkey creation message that notifies the user device 102 to create a passkey. The digital wallet server computer 108 can provide the passkey creation message to the resource provider computer 106.

At step 828, after receiving the passkey creation message from the digital wallet server computer 108, the resource provider computer 106 can provide the passkey creation message to the user device 102.

After receiving the passkey creation message, the user device 102 can generate the passkey. For example, the user device 102 can generate a public key and a corresponding private key for use in the passkey system. The user device 102 can securely store the private key, which can later be utilized for authentication of the user when using the additional user device. The user device 102 can provide the public key the relying party computer 110.

In some embodiments, the user can make a selection to only use the passkeys for a one-time interaction on the user device 102.

At step 832, the digital wallet server computer 108 can provide the credentials for the interaction that were received from the primary user device 800 (e.g., a selected credential or identifier thereof from step 708) to the resource provider computer 106.

At step 834, the resource provider computer 106 can mask the credentials and display (e.g., via the resource provider webpage) the masked credentials on the user device 102 for the interaction. The original session between the user device 102 and the resource provider computer 106 can be resumed during step 834.

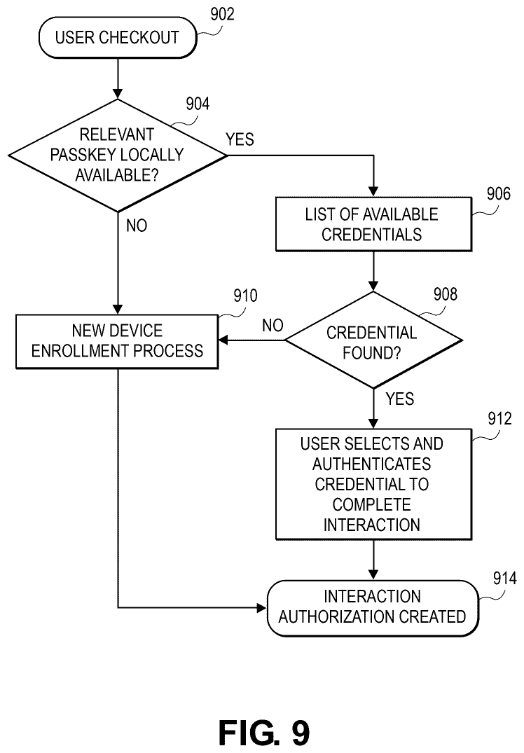

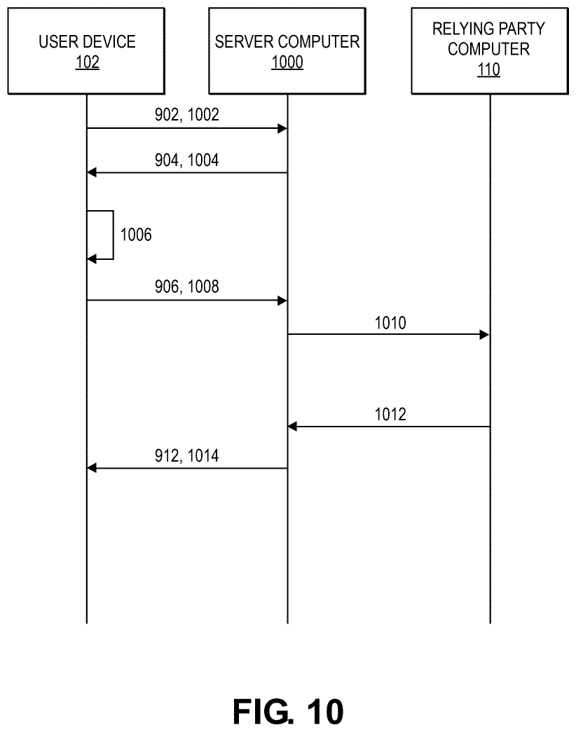

This section details the process, and systems flows for presenting the registered credentials with the digital wallet server computer 108 using passkeys. The process and flows illustrated in FIGS. 9-10 describe credential discovery methods. The provisioned passkeys can be provisioned as discoverable. The data needed to be able to discover the available registered credentials includes the relying party identifier that is used to discover the associated credential identifiers on the device. Such an identification scheme can be based on W3C WebAuthn specifications that discusses the technical implementation of discoverable credentials. The methods described in this section provide for the technical advantage of avoiding the need for the user to enter any manual personally identifiable information, or account identifiers, and relies on the authentication of the device authenticator and passkeys to display the available credentials that have been registered previously.

FIG. 9 shows a flow diagram of a first registered credential discovery method according to embodiments. FIG. 10 shows a flow diagram of a second registered credential discovery completion method according to embodiments.

The method illustrated in FIGS. 9 and 10 can include the use of a server computer 1000 that includes both the resource provider computer 106 and the digital wallet server computer 108. The server computer 1000 can include functionalities from both the resource provider computer 106 and the digital wallet server computer 108. These components can all be implemented as an interface, system, or they can be separate entities each focusing on processing one area of the method. Additionally, there could be SDKs provided by the digital wallet server computer 108 to the resource provider webpage to implement and use to complete the discovery and presentation steps.

At step 902 and 1002, the user device 102 can initiate a checkout process for an interaction with the server computer 1000 that includes the resource provider computer 106 and the digital wallet server computer 108. The server computer 1000 can host a webpage (e.g., a resource provider webpage) that is accessible by the user device 102.

For example, the user device 102 can generate an interaction request message (e.g., a checkout message). The interaction request message can comprise one or more resources that are to be provided by the resource provider to the user after completion of the interaction. The user device 102 can provide the interaction request message to the server computer 1000.

At steps 904 and 1004, a check can be performed to detect any discoverable passkeys stored on the user device 102 using the relying party identifier. For example, the server computer 1000 can transmit a relying party identifier associated with the relying party computer 110 to the user device 102.

The user device 102 can utilize the relying party identifier to determine whether or not any passkeys are locally available. If no passkeys are locally available, then process can proceed to step 910. If passkeys are locally available, then process can proceed to step 906.

At step 1006, the user device 102 can determine whether or not to allow passkey discovery. In some embodiments, the user device can default to allowing passkey discovery. In some embodiments, the discovery could additionally be protected and only allowed after a user gives consent for the discovery. This can be an additional layer of security that can be implemented by the authenticator on the user device 102 prior to allowing the discovery.

At steps 906 and 1008, the user device 102 can obtain a list of credentials (e.g., primary account numbers) or identifiers thereof (e.g., primary account number reference identifiers) based on the relying party identifier. For example, each credential or identifier thereof can be stored in association with a relying party identifier in the user device 102. The user device 102 can determine if any stored relying party identifiers match the received relying party identifier. The user device 102 can provide the list of credentials or identifiers thereof to the server computer 1000.

For example, during step 1008, the user device 102 can determine a list of credentials or identifiers thereof based on the relying party identifier. The user device 102 can provide the list of credentials or the identifiers thereof to the server computer 1000.

At step 908, the server computer 1000 can determine if a credential or identifier thereof was discovered on the user device 102. If no credential or identifier thereof was discovered on the user device 102, then process can proceed to step 910. If one or more credentials or identifiers thereof were discovered on the user device 102, then process can proceed to step 912.

At step 910, if the user device 102 does not find a credential that is to be used in the interaction, then the user device can provide the option to the user to register additional credentials. The user device 102 can register additional credentials as described herein.

At step 1010, after obtaining the list of credentials or identifiers thereof, the server computer 1000 can query the relying party computer (e.g., a passkey relying party) for a token and metadata related to the list of credentials or identifiers thereof. For example, the server computer 1000 can generate a token request message comprising the list of credentials or identifiers thereof. The server computer 1000 can provide the token request message to the relying party computer 110.

At step 1012, the server computer 1000 can obtain tokens and metadata for each credential or identifier thereof for the list of credentials or identifiers thereof. The token and metadata can be stored in association with a credential. The relying party computer 110 can identify the token using the credential or the identifier of the credential. The metadata can include data related to the credential and/or the portable device (e.g., physical card) associated with the credential. The metadata can include, for example, card art, user photos, user customizations, etc.

The relying party computer 110 can generate a token response message comprising a list of tokens and metadata. The relying party computer 110 can provide the token response message to the server computer 1000. The server computer 1000 can obtain the one or more tokens associated with credentials of the list of credentials.

At steps 912 and 1014, after receiving the token response message, the server computer 1000 can present each token and associated metadata to the user device via the resource provider webpage. The server computer 1000 can display the card art from the metadata for each token. The displayed tokens can be selectable by the user of the user device 102.

If one or more credentials or identifiers thereof were discovered, then the user device 102 can select a selected credential or identifier thereof from the list of credentials or identifiers thereof. In some embodiments, the user device 102 can also authenticate the user prior to allowing the user to access and/or utilize the credential or identifier thereof. For example, if the user chooses a credential, then a challenge is generated, and passkey authentication takes place to allow the usage of the credentials. For example, the user device 102 can authenticate a user biometric. If the user is not authenticated, then the process can terminate.

At step 914, after the user is authenticated, the server computer 1000 can generate an authorization request message for the interaction. The authorization request message can be provided to an authorizing entity computer, as described herein, for authorization of the interaction.

The user of the user device 102 can select a token of the list of tokens presented by the resource provider webpage. Upon receiving the selection of the token to utilize for the interaction, the server computer 1000 can generate an authorization request message comprising the token. The server computer 1000 can provide the authorization request message to a transport computer. The transport computer can provide the authorization request message to a network processing computer. The network processing computer can provide the authorization request message to an authorizing entity computer for authorization.

The authorizing entity computer can determine whether or not to authorize the interaction. The authorizing entity computer can generate an indication of whether or not the interaction is authorized. The authorizing entity computer can generate an authorization response message comprising the indication of whether or not the interaction is authorized. The authorizing entity computer can provide the authorization response message to the network processing computer. The network processing computer can provide the authorization response message to the transport computer. The transport computer can provide the authorization response message to the server computer 1000. The server computer 1000 can display the indication of whether or not the interaction is authorized on the resource provider webpage displayed on the user device 102 to the user.

After the interaction is authorized, a clearing and/or settlement process can occur between the network processing computer, the authorizing entity computer, and a transport computer associated with the resource provider.

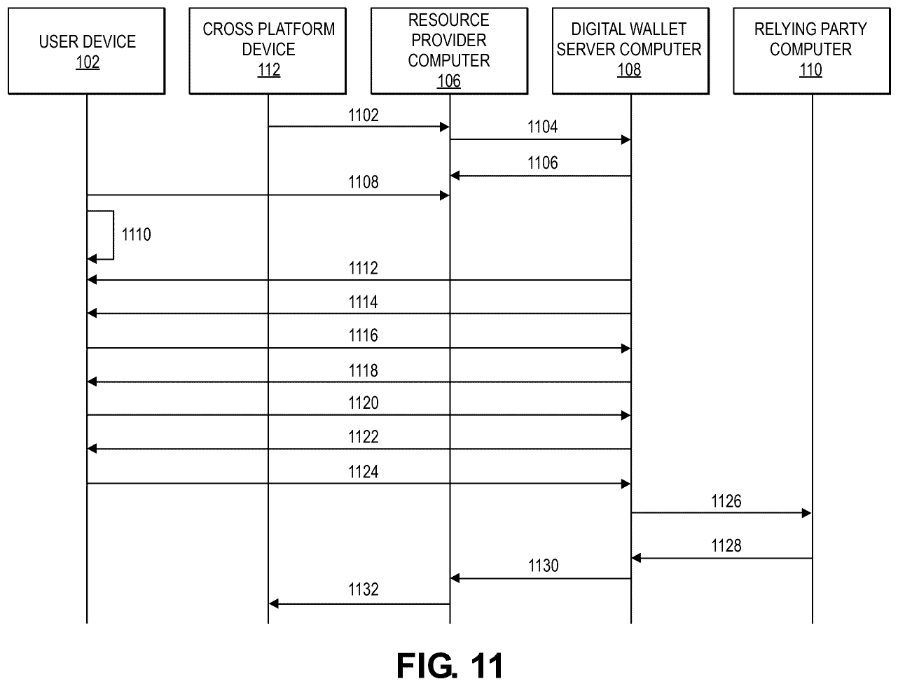

FIG. 11 shows a method to support temporary use of credentials registered with a passkey on a device to conduct a one-time interaction on another device. The user may not want to register the credential with a passkey on a device that is being used to conduct the interaction, as it could be a non-trusted device (e.g., a device operated by the resource provider, a public entity, etc.). However, without the need to perform a complicated process of authentication, a user can use a registered device (e.g., a primary user device) to authorize the interaction and authenticate themselves while the interaction is performed on the non-trusted device. This leverages passkeys on the registered device combined with either a dynamically generated QR code or Bluetooth and NFC technologies, to fulfil the requirements of authorization and authentication.

The difference in process between the process flow presented in the registration of an additional device (e.g., as depicted in FIG. 8) and the use of a primary user device to complete the transaction on the additional device without registration (e.g., as depicted in FIG. 11) is that instead of creating a passkey on the additional user device and using the passkey to process the interaction, a passkey from the primary user device is used to generate the interaction authorization and complete the interaction on the additional user device. This allows for using the primary user device passkeys for a one-time temporary completion of an interaction on a user device that the user does not trust or want to add passkeys to. The user device that the user does not want to register with, but is used to initiate the interaction is referred to as the cross platform device 112.

At step 1102, the user of the user device 102 can initiate a checkout process on the cross platform device 112. For example, the user can select to checkout for an interaction between the user and a resource provider that is associated with the resource provider computer 106 and potentially with the cross platform device 112. The user can select to checkout using a user interface displayed on the cross platform device 112. The user interface can display, for example, a webpage hosted by the resource provider computer 106.

The user can select to authenticate with a registered device (e.g., the user device 102) rather than add a new passkey to the cross platform device 112. The cross platform device 112 can generate an interaction request message that comprises an indication that the user has selected to authenticate with a registered device (e.g., a use registered device flag). The interaction request message can include a user identifier that identifies the user such that the digital wallet server computer 108 can later identify an authentication account associated with the user. The user identifier can include a primary account number, a username, a full name, an alphanumeric code, or other uniquely identifying value. The interaction request message can also include interaction data that is related to the interaction. For example, the interaction data can include a date, a time, a cross platform device identifier, a resource provider computer identifier, an amount, and/or other data related to processing or fulfilling the interaction.

The cross platform device 112 can transmit the interaction request message to the resource provider computer 106. For example, the cross platform device 112 can provide the interaction request message to the resource provider computer 106 via the webpage hosted by the resource provider computer.

In some embodiments, the user can choose to enter limited credential details into the cross platform device 112 for the interaction. The credential details can include a credential such as a primary account number and, in some cases, an expiration date. The credential details may not include a card verification value (CVV) to minimize the exposure of all credential details. By entering limited credential details into the cross platform device 112, later in the process, the digital wallet server computer 108 can evaluate the limited credential details to determine if the credential has been registered previously. If so, then the user can be prompted to use the user device 102 to complete the authorization and authentication.

At step 1104, after receiving the interaction request message, the resource provider computer 106 identify that interaction request message includes an indication that the user has selected to authenticate with a registered device. The resource provider computer 106 can generate a machine readable code request message. The machine readable code request message can request a machine readable code from the digital wallet server computer 108. The machine readable code can be a bar code, a QR code, etc. that can be read by a device using a camera or other scanning means.

In some embodiments, the resource provider computer 106 can obtain a session identifier that uniquely identifies a session between the cross platform device 112 and the resource provider computer 106. A session identifier can be a piece of data that is used in network communications (often over HTTPS) to identify a session, a series of related message exchanges. The resource provider computer 106 can include the session identifier into the machine readable code request message. The session identifier can later be utilized by the resource provider computer 106 to identify the current session between the cross platform device 112 and the resource provider computer 106 after the user has been authenticated using the user device 102.

The resource provider computer 106 can provide the machine readable code request message to the digital wallet server computer 108. The machine readable code request message can request a dynamic QR code.

At step 1106, the digital wallet server computer 108 can create the machine readable code (e.g., the dynamic QR code). The machine readable code can be for the user to scan using the user device 102 to continue the processing of the interaction and authentication of the user using the user device 102.

The digital wallet server computer 108 can generate a machine readable code response message comprising the machine readable code. The digital wallet server computer 108 can provide the machine readable code response message to the resource provider computer 106.

After receiving the machine readable code, the resource provider computer 106 can display the machine readable code on the resource provider webpage that is being access by and displayed on the cross platform device 112. As such, the machine readable code can be displayed on a screen of the cross platform device 112.

At step 1108, the user device 102 (e.g., the primary user device) can scan the machine readable code displayed on the cross platform device 112 that is displaying the machine readable code from the resource provider computer webpage. The user device 102 can scan the machine readable code using a camera in the user device 102.

At step 1110, the user device 102 is redirected to a digital wallet server computer webpage hosted by the digital wallet server computer. For example, the machine readable code can be a dynamic QR code that provides a URL to the user device 102. The user device 102 can access the URL using a web browser and can access a webpage indicated by the URL. The user device 102 can load and display the accessed webpage.

In some embodiments, at step 1112, upon detecting that the user device 102 connected to the digital wallet server computer webpage, the digital wallet server computer 108 can generate an authentication challenge. The authentication challenge can include a challenge for the user of the user device 102 to authenticate themselves to the user device.

In some embodiments, when a user attempts to use a credential, the digital wallet server computer 108 generates a random authentication challenge that includes, for example, a cryptographic nonce and sends the authentication challenge to the user device 102. This authentication challenge can then be digitally signed by a secure element, authentication module, or other trusted software and/or hardware in the user device. The authentication challenge can be signed using the private key associated with the registered passkey. The digital wallet server computer 108 or relying party computer 110 can then verify the digital signature using the public key that is stored and registered to confirm user's identity.

For example, after obtaining the digital signature, the digital wallet server computer 108 can obtain a relying party identifier from a memory, where the relying party identifier identifies the relying party computer 110 that is associated with the computer. The relying party computer 110 can be associated with the passkey utilized for the user device 102. The digital wallet server computer 108 can provide the digital signature to the relying party computer 110. The relying party computer 110 can validate a digital signature using a stored public key that corresponds to a private key utilized by the user device 102 to form the digital signature.

At step 1114, the digital wallet server computer 108 can discover the available credential or identifiers thereof on the user device 102. For example, the digital wallet server computer 108 can generate a discovery request message. The discovery request message can include a relying party identifier associated with the relying party computer 110. The discovery request message can request credentials or identifiers thereof that are associated with the relying party computer 110 that are stored in the user device 102.

The digital wallet server computer 108 can provide the discovery request message to the user device 102.

At step 1116, after receiving the discovery request message, the user device 102 can determine a list of credentials or identifiers thereof based on the relying party identifier. For example, the user device 102 can store a plurality of credentials. Each credential of the plurality of credentials can be stored in association with a particular relying party identifier. The user device 102 can identify credentials of the plurality of credentials that are associated with a relying party identifier that matches the received relying party identifier. The user device 102 can add the relevant credentials to the list of credentials.

The user device 102 can create a discovery response message that comprises the list of credentials or identifiers thereof. The user device 102 can provide the discovery response message to the digital wallet server computer 108.

At step 1118, after receiving the list of credentials or the identifiers thereof, the digital wallet server computer 108 can generate a list of selectable credentials or identifiers thereof to use for the interaction. The digital wallet server computer 108 can generate the list of selectable credentials or identifiers thereof from the list of credentials or identifiers thereof. The list of selected credentials can be a subset of the list of credentials.

For example, some credentials may not be relevant to the current interaction or are not authorized for the current interaction type. For example, three credentials may be respectively related to a credit card, a debit card, and a prepaid card. The current interaction may not allow credit card based purchases. The digital wallet server computer 108 can filter the list of credentials based on interaction rules to determine the list of selectable credentials. For example, the list of selectable credentials can include two credentials that respectively relate to a debit card and a prepaid card.

The digital wallet server computer 108 can generate a credential selection request message that requests the user of the user device 102 to select a credential. The credential selection request message can include the list of selectable credentials or identifiers thereof. The digital wallet server computer 108 can provide the credential selection request message to the user device 102.

In some embodiments, the list of selectable credentials can be a list of masked selectable credentials. The digital wallet server computer 108 can mask each of the selectable credentials such that the full credential is not transmitted or displayed by the user device 102. The digital wallet server computer 108 can mask a credential by obfuscating a portion of the credential. For example, the digital wallet server computer 108 can mask a credential of “01234567890123456” to “*************3456.”

At step 1120, after receiving the credential selection request message, the user device 102 can obtain a selected credential or identifier thereof from the list of selected credentials or identifiers thereof. For example, the user device 102 can display the list of selected credentials or identifiers thereof to the user via a display screen in the user device 102. The user can input a selection that indicates a particular selected credential or identifier thereof.

The user device 102 can generate a credential selection response message that comprises the selected credential or identifier thereof. The user device 102 can provide the credential selection response message to the digital wallet server computer 108.

At step 1122, after obtaining the selected credential or identifier thereof, the digital wallet server computer 108 can initiate an authentication challenge for the user device 102. The authentication challenge can be a user authentication challenge. The authentication challenge can include a challenge for the user to biometrically authenticate themselves using the user device 102.

The digital wallet server computer 108 can provide the authentication challenge to the user device 102.

At step 1124, the user device 102 can perform an authentication process to authenticate the user of the user device 102. The user device 102 can prompt the user to input a biometric, a password, or other secure information for verification. The user device 102 can compare the input data to stored data to determine whether or not the user input the correct data.

For example, the user device 102 can prompt the user to input a fingerprint biometric. The user device 102 can receive a fingerprint biometric from the user using a fingerprint scanner. The user device 102 can compare the input fingerprint biometric to a stored fingerprint biometric. The user device 102 can determine whether or not the fingerprint biometric matches the stored fingerprint biometric. If the biometrics match, then the user device 102 can determine that the user is authentic. The user device 102 can generate authentication data that indicates whether or not the user is authenticated.

The user device 102 can sign authentication data or other data related to the authentication challenge to form a digital signature using a private key that is stored securely in the user device 102 that corresponds to a public key that is registered with the relying party computer 110.

The user device 102 can generate an authentication response message in response to the authentication challenge. The user device 102 can generate the authentication response message based on the outcome of authenticating the user. The authentication response message can be or include the digital signature.

After generating the authentication response message, the user device 102 can provide the authentication response message to the digital wallet server computer 108 in response to the authentication challenge.

At step 1126, after receiving the authentication response message, the digital wallet server computer 108 can generate a validation request message that requests the relying party computer 110 to validate the authentication response message and/or data included therein. The validation request message can include the authentication response message.

The digital wallet server computer 108 can provide the validation request message to the relying party computer 110.

At step 1128, after receiving the validation request message, the relying party computer 110 can validate the authentication response to the authentication challenge. For example, the relying party computer 110 can validate the digital signature using a registered public key that is associated with the user device 102. The public key can correspond to the private key used to create the digital signature. The relying party computer 110 can determine whether or not the authentication response is valid.

The relying party computer 110 can generate a validation response message that indicates whether or not the authentication response is valid. The relying party computer 110 can provide the validation response message to the digital wallet server computer 108 in response to the validation request message.

At step 1130, if the authentication response is valid, the digital wallet server computer 108 can obtain the selected credential for the interaction and provide the selected credential to the resource provider computer 106 for later submission to an authorizing entity computer for authorization of the interaction.

In some embodiments, the digital wallet server computer 108 can identify a token that is stored in association with the selected credential in a token vault or other database. The digital wallet server computer 108 can replace the selected credential with the token for use in the interaction to keep the credential secure from the resource provider computer 106. The digital wallet server computer 108 can provide the token to the resource provider computer 106. In some embodiments, the relying party computer 110 can provide a token associated with the selected credential along with the validation response message to the digital wallet server computer 108.

At step 1132, the resource provider computer 106 can display the selected credential, token, or masked value thereof on the cross platform device 112 on the resource provider computer webpage to the user.

In some embodiments, the resource provider computer 106 and the cross platform device 112 can proceed with the interaction automatically. In other embodiments, the resource provider computer 106 can request the user to confirm the selected credential or token on the cross platform device 112.

The interaction can then be completed using the cross platform device 112 and the resource provider computer 106. For example, the resource provider computer 106 can generate an authorization request message comprising the selected credential or token. The authorization request message can also include the interaction data for the interaction between the resource provider and the user. The resource provider computer 106 can provide the authorization request message to an authorizing entity computer for authorization as described herein for interaction authorization.

Embodiments of the disclosure have a number of advantages. For example, a user does not need to enter a password, email address, or other personally identifiable information into an untrusted device or into a webpage. Embodiments provide for the advantage of replacing the user's personally identifiable information based login credentials for online interactions.

In previous methods, in the case of a data breach, a user's private data that is used for authentication was lost to malicious parties. Embodiments solve the technical problem of limiting the exposure of private data to data breaches. According to embodiments, if the relying party computer were to have a data breach and have all of its data exposed to malicious parties, the malicious parties could not perform phishing attacks or other security attacks using the exposed data. Rather, a malicious party could only access a public key of the user device from a potential data breach. The malicious party cannot use the public key in any way to perform phishing attacks or other security attacks.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a computer, an interaction request message;
transmitting, by the computer to a user device, a relying party identifier associated with a relying party computer, wherein the user device thereafter determines a list of credentials or identifiers thereof based on the relying party identifier; and
receiving, by the computer, the list of credentials or identifiers thereof from the user device, wherein the computer conducts an interaction using a credential, identifier thereof, of the list of credentials or identifiers thereof.

2. The method of claim 1, further comprising:
transmitting, by the computer to the relying party computer, the list of credentials or identifiers thereof; and
obtaining, by the computer from the relying party computer, one or more tokens associated with credentials of the list of credentials.

3. The method of claim 2, further comprising:
providing, by the computer, the one or more tokens to the user device, wherein the user device obtains a selected token of the one or more tokens; and
receiving, by the computer, the selected token from the user device.

4. The method of claim 3, further comprising:
performing, by the computer, an interaction with the user device using the selected token.

5. The method of claim 4, wherein performing the interaction further comprises:
generating, by the computer, an authorization request message comprising the selected token and interaction data;
providing, by the computer, the authorization request message to a transport computer, wherein the transport computer provides the authorization request message to a network processing computer, wherein the network processing computer provides the authorization request message to an authorizing entity computer, wherein the authorizing entity computer determines whether or not to authorize the interaction associated with the selected token and generates an authorization response message comprising an indication of whether or not the interaction is authorized; and
receiving, by the computer, the authorization response message from the authorizing entity computer via the network processing computer and the transport computer.

6. The method of claim 1, wherein the user device stores a plurality of credentials or identifiers thereof, and wherein the list of credentials or identifiers thereof are a subset of the plurality of credentials or identifiers thereof that are related to the relying party identifier.

7. The method of claim 1, wherein the relying party computer is configured to authenticate the user device by verifying a digital signature produced by a private key on the user device, using a public key stored on the relying party computer.

8. The method of claim 1, wherein the user device is a primary user device, wherein the interaction request message is received from an additional user device, and wherein the interaction request message includes an enrollment request.

9. The method of claim 8, wherein the method further comprises:
generating, by the computer, a machine readable code request message;
providing, by the computer, the machine readable code request message to a storage application server computer, wherein the storage application server computer generates a machine readable code;
receiving, by the computer, a machine readable code response message from the storage application server computer, wherein the machine readable code response message comprises the machine readable code; and
displaying, by the computer, the machine readable code on the additional user device via a webpage hosted by the computer, wherein the webpage displays a prompt to scan the machine readable code with the primary user device for enrollment of the additional user device.

10. The method of claim 9, wherein the machine readable code is a QR code.

11. The method of claim 9, wherein the primary user device is redirected by the machine readable code to communicate with the storage application server computer to enroll the additional user device, wherein after authenticating the user of the primary user device, the storage application server computer generates a passkey creation message, wherein the method further comprises:
receiving, by the computer, the passkey creation message from the storage application server computer; and
providing, by the computer, the passkey creation message to the additional user device, wherein the additional user device generates a passkey comprising a cryptographic public key and a cryptographic private key, wherein the additional user device provides the cryptographic public key to the relying party computer for use in interactions.

12. The method of claim 1, further comprising:
obtaining, by the computer, the relying party identifier from a memory, wherein the relying party identifier identifies a relying party computer that is associated with the computer, and wherein the relying party computer validates a digital signature using a stored public key that corresponds to a private key utilized by the user device to form the digital signature.

13. The method of claim 1, wherein the computer is a resource provider computer.

14. A computer comprising:
a processor; and
a non-transitory computer readable medium comprising code, executable by the processor for performing a method comprising:
receiving an interaction request message;
transmitting, to a user device, a relying party identifier associated with a relying party computer, wherein the user device thereafter determines a list of credentials or identifiers thereof based on the relying party identifier; and
receiving the list of credentials or identifiers thereof from the user device, wherein the computer conducts an interaction using a credential, identifier thereof, of the list of credentials or identifiers thereof.

15. The computer of claim 14, wherein the computer is a server computer that comprises a resource provider computer and a storage application server computer.

16. The computer of claim 14, wherein the method further comprises:
obtaining, by the computer, a list of tokens corresponding to the list of credentials or identifiers thereof from the relying party computer;
providing, by the computer, the list of tokens to the user device, wherein the user device obtains a selected token of the list of tokens; and
receiving, by the computer, the selected token from the user device, wherein the selected token is used to conduct the interaction.

17. The computer of claim 14, wherein the interaction request message comprises an amount, a time, a user device identifier, and a computer identifier, wherein the interaction request message is received from the user device, wherein the user device is a primary user device.

18. The computer of claim 14, wherein the list of credentials or identifiers thereof includes a list of credentials associated with and identified by public keys of passkeys.

19. A method comprising:
receiving, by a user device from a computer during an interaction, a relying party identifier associated with a relying party computer;
determining, by the user device, a list of credentials or identifiers thereof based on the relying party identifier;
providing, by the user device, the list of credentials or identifiers thereof to the computer, wherein the computer obtains a list of tokens corresponding to the list of credentials or identifiers thereof from the relying party computer;
receiving, by the user device from the computer, the list of tokens;
obtaining, by the user device, a selected token of the list of tokens; and
providing, by the user device, the selected token for use in the interaction.

20. The method of claim 19, wherein the user device is a primary user device, wherein the computer is a resource provider computer, a storage application server computer, or a combination thereof.
